(19) United States
(12) Patent Application Publication
(10) Pub. No.: US 2026/0329109 A1
(43) Pub. Date: Oct. 22, 2026

(54) METHODS, APPARATUSES, AND SYSTEMS FOR STABILIZATION OF OUTPUTTED CONTENT

(71) Applicant: Comcast Cable Communications, LLC, Philadelphia, PA (US)

(72) Inventors: Yuvaraj ANBAZHAGAN, CHENNAI (IN); Rajasekaran NATARAJAN, CHENNAI (IN); Keerthanaa PALANIVEL, CHENNAI (IN)

(21) Appl. No.: 19/183,479

(22) Filed: Apr. 18, 2025

(51) Int. Cl. G02B 27/64; H04N 5/262

(52) U.S. Cl. CPC G02B 27/648; H04N 5/2628

(57) ABSTRACT

Methods, devices, and systems are described for stabilizing the outputting of content. The output device may take into account the movements experienced by the output device when outputting the content to the user. The output device may determine when the output device experiences sudden movements, and may adjust the output parameters to adjust for the sudden movements. For example, the content may be outputted at a smaller size such that the content may not fill the entire display of the output device. The center point of the content may be shifted, the content may be rotated on the display etc., according to the sudden movement. Thus, the changes in the output of the content may mitigate the movement of the content as the output device is moving in relation to the user, which may further enhance the viewability of the content.

### BACKGROUND

Certain devices, such as mobile phones and tablets, may output content to a user. These devices may in some cases be held by a user to view content, or may be transportable while outputting content. However, in some cases these devices may experience shakes or vibrations due to surrounding conditions. For example, a user may be holding a mobile phone to watch content while on a bus. When the bus is moving, the mobile phone may experience jolts or shakes due to movement of the bus. This may cause quick repositioning of the of the mobile phone in relation to the user, which may cause difficulties in the user's ability to view the outputted content.

### SUMMARY

Systems, methods, and apparatuses are described for stabilization of outputted content. A computing device, such as a mobile phone, may output content via a display of the computing device. The computing device may experience movement while outputting the content, such as due to a jolt or shake experienced by the computing device. Due to the movement, the orientation of the output may be altered with respect to the user watching the content. The computing device may determine the change in the orientation of the display with respect the user, and may modify output parameters of the content, such as an angle of rotation or a center point for the content with respect to the initial orientation. Based on the angle of rotation and/or the new center point for the content, the computing device may determine a size for the content, such that the content may fit within the display of the computing device without having portions of the content broken off or cut from view due to the dimensions of the display. The content may be outputted according to the modified output parameters and updated size, which may facilitate the stabilization of the content being viewed by the user while the computing device is moving.

### BRIEF DESCRIPTION OF DRAWINGS

The accompanying drawings, which are incorporated in and constitute a part of this specification, show embodiments and together with the description, serve to explain the principles of the methods and systems:

FIG. 1 shows an example system;

FIG. 2 shows an example computing device;

FIG. 3 shows an example method;

FIG. 4 shows an example method;

FIG. 5 shows an example computing device;

FIG. 6A-6C show example computing devices;

FIG. 7 shows an example method; and

FIG. 8 shows an example computing device.

### DETAILED DESCRIPTION

Methods, devices, and systems are described for stabilizing the outputting of content. Personal output devices, such as mobile phones and tablets, may experience sudden jolts or shakes while content is being outputted. For example, the user may be walking while viewing content on the device, or the user may be sitting on a bus or train that experiences bumps while travelling. The jolts or shakes may make it difficult for the user to properly view the content, as the output's orientation may be shifting with respect to the user.

According to the present disclosure, the output device may take into account the movements experienced by the output device when outputting the content to the user. For example, the content may be initially outputted to the user with a given set of output parameters such as a content width, a content height, a center point of the content, a rotational angle of the content, a content aspect ratio, etc. In some cases, these initial output parameters may correspond to a landscape mode or portrait mode of the output device. The output device may also determine when the output device experiences sudden movements, and may adjust the output parameters to adjust for the sudden movements. For example, the content may be outputted at a smaller size (e.g., aspect ratio) such that the content may not fill the entire output screen of the output device (e.g., so as to not be cut off near screen corners). The center point of the content may be shifted, the content may be rotated on the display (e.g., 5 degrees from the landscape mode) etc., according to the sudden movement. Thus, the changes in the output of the content may mitigate the movement of the content as the output device is moving in relation to the user, which may further enhance the viewability of the content.

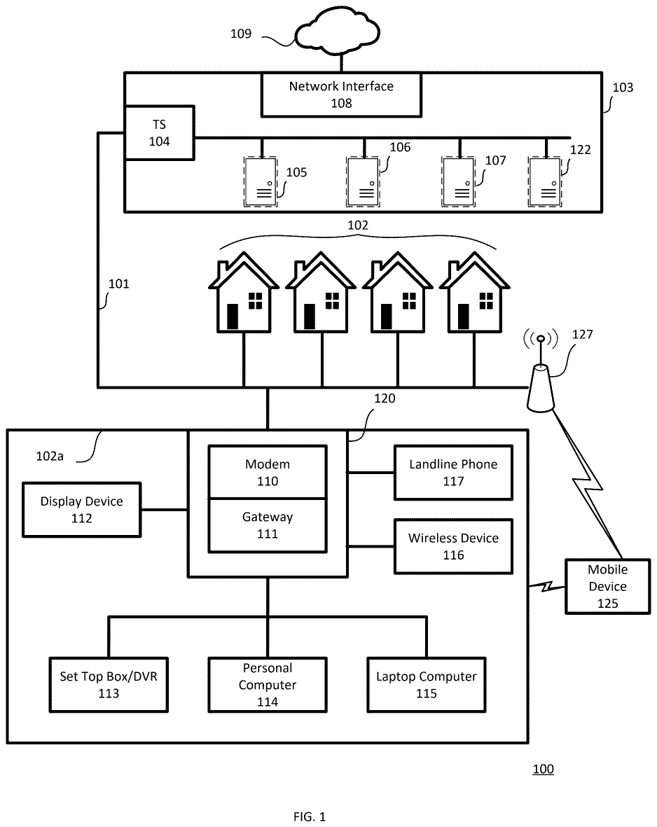

FIG. 1 shows an example communication network 100 in which features described herein may be implemented. The communication network 100 may be any type of information distribution network, such as satellite, telephone, cellular, wireless, etc. Examples may include an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may transmit downstream information signals and receive upstream information signals via the communication links 101. Each of the premises 102 may have equipment, described below, to receive, send, and/or otherwise process those signals.

The communication links 101 may originate from the local office 103 and may be split to exchange information signals with the various premises 102. The communication links 101 may include components not shown, such as splitters, filters, amplifiers, etc. to help convey the signal clearly. The communication links 101 may be coupled to an access point 127 (e.g., a base station of a cellular network, a Wi-Fi access point, etc.) configured to provide wireless communication channels to communicate with one or more mobile devices 125. The mobile devices 125 may include cellular mobile devices, and the wireless communication channels may be Wi-Fi IEEE 802.11 channels, cellular channels (e.g., LTE), and/or satellite channels.

The local office 103 may include a first interface 104, such as a termination system (TS). The first interface 104 may be a cable modem termination system (CMTS), which may be a computing device configured to manage communications between devices on the network of the communication links 101 and backend devices such as servers 105-107 and 122. The first interface 104 may be configured to place data on one or more downstream frequencies to be received by modems at the various premises 102, and to receive upstream communications from those modems on one or more upstream frequencies.

The local office 103 may also include one or more network interfaces 108 which may permit the local office 103 to communicate with various other external networks 109. The external networks 109 may include, for example, networks of Internet devices, telephone networks, cellular telephone networks, fiber optic networks, local wireless networks (e.g., WiMAX), satellite networks, a cloud network, and any other desired network, and the network interface 108 may include the corresponding circuitry needed to communicate on the external networks 109, and to other devices on the external networks. For example, the local office 103 may also or alternatively communicate with a cellular telephone network and its corresponding mobile devices 125 (e.g., cell phones, smartphone, tablets with cellular radios, laptops communicatively coupled to cellular radios, etc.) via the interface 108. Further, in some cases, any or all of the components of the local office 103 may be a part of a cloud network. For example, any of the servers of the local office 103 may be a cloud server or servers. In some cases, any or all of the servers shown in the local office 103 may be part of the external network 109, such as a cloud network 109.

The advertisement server 105 may provide advertisement content or associated data for download by a user device. The content server 106 may be one or more computing devices that are configured to provide content to devices at premises. This content may be, for example, video on demand movies, television programs, songs, text listings, web pages, articles, news, images, files, etc. The content server 106 may include software to locate and retrieve requested content and to initiate delivery (e.g., streaming) of the content to the requesting user(s) and/or device(s). The application server 107 may be a computing device configured to offer any desired service, and may execute various languages and operating systems (e.g., servlets and JSP pages running on Tomcat/MySQL, OSX, BSD, Ubuntu, Redhat, HTMLS, JavaScript, AJAX and COMET). For example, an application server may be responsible for collecting television program listings information and generating a data download for electronic program listings. Another application server may be responsible for monitoring user viewing habits and collecting that information for use in selecting advertisements. Yet another application server may be responsible for formatting and providing advertisement information to a user device. Yet another application server may receive login credentials of a user and validate the user for access to content (e.g., provided by a content server). Yet another application server may receive advertisement telemetry data from a user device. Another application server may be a gaming server configured to execute gaming programs. The local office 103 may include additional servers, including a controller server 122, additional push, content, and/or application servers, and/or other types of servers. Although shown separately, the advertisement server 105, the content server 106, the application server 107, the controller server 122, and/or other server(s) may be combined. The servers 105, 106, 107, and 122, and/or other servers, may be computing devices and may include memory storing data and also storing computer executable instructions that, when executed by one or more processors, cause the server(s) to perform steps described herein.

An example premises 102 a may include a second interface 120. The second interface 120 may include any communication circuitry used to communicate via one or more of the links 101. The second interface 120 may include a modem 110, which may include transmitters and receivers used to communicate via the links 101 with the local office 103. The modem 110 may be, for example, a coaxial cable modem (for coaxial cable lines of the communication links 101), a fiber interface node (for fiber optic lines of the communication links 101), twisted-pair telephone modem, cellular telephone transceiver, satellite transceiver, local Wi-Fi router or access point, or any other desired modem device. One modem is shown in FIG. 1, but a plurality of modems operating in parallel may be implemented within the second interface 120. The second interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the local office 103 and other devices beyond the local office 103. The gateway interface device 111 may comprise a set-top box (STB), digital video recorder (DVR), a digital transport adapter (DTA), computer server, network-capable “smart” TVs with embedded processors, and/or any other desired computing device. The gateway interface device 111 may also include local network interfaces to provide communication signals to requesting entities/devices in the premises 102 a, such as display devices 112 (e.g., televisions), additional STBs or DVRs 113, personal computers/laptop 114, network-capable “smart” TVs, 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA), etc.), landline phones 117 (e.g., Voice over Internet Protocol-VoIP phones), wireless “smart” TVs, and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

One or more of the devices at a premises 102 a may be configured to provide wireless communications channels (e.g., IEEE 802.11 channels) to communicate with a mobile device 125. A modem 110 (e.g., access point) or a wireless device 116 (e.g., router, tablet, laptop, etc.) may wirelessly communicate with one or more mobile devices 125, which may be on- or off-premises.

Mobile devices 125 may communicate with a local office 103 including, for example, with the controller server 122. Mobile devices 125 may be cell phones, smartphones, tablets (e.g., with cellular transceivers), laptops (e.g., communicatively coupled to cellular transceivers), wearable devices (e.g., smart watches, electronic eye-glasses, etc.), or any other mobile computing devices. Mobile devices 125 may store, output, and/or otherwise use assets. An asset may be a video, a game, one or more images, software, audio, text, webpage(s), and/or other content. Mobile devices 125 may include Wi-Fi transceivers, cellular transceivers, satellite transceivers, and/or global positioning system (GPS) components.

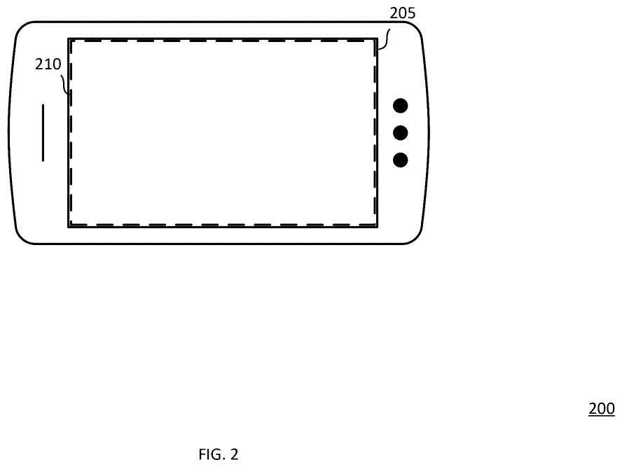

FIG. 2 shows a computing device 200 according to the present disclosure. In some cases, the computing device 200 may be an example of the mobile device 125 of FIG. 1. Thus, the computing device 200 may be an example of a mobile phone, a tablet, a laptop, a smart watch, a game console, etc. The computing device 200 may include a display 205. The display 205 may be configured to output content via the display 205. For example, the computing device 200 may output content (e.g., a video) via the display 205.

The display 205 may include a preconfigured size. For example, the display 205 may be a two-dimensional display defining a plane. The display 205 may include a width (w) and length (1). The area defined by the display 205 may be configured to display content (e.g., to a user).

The computing device 200 may configure content to be outputted by the display 205. For example, the computing device 200 may receive content for output. The computing device 200 may adjust the size of the content in order to fit within the display 205. For example, the display 205 may be composed of a number of pixels, which may further define the width and length of the display 205. The computing device 200 may modify the content such that the content may fit according to the size of the display 205. Thus, the size of the outputted content 210 can be said to be less than or equal to the dimensions of the display 205.

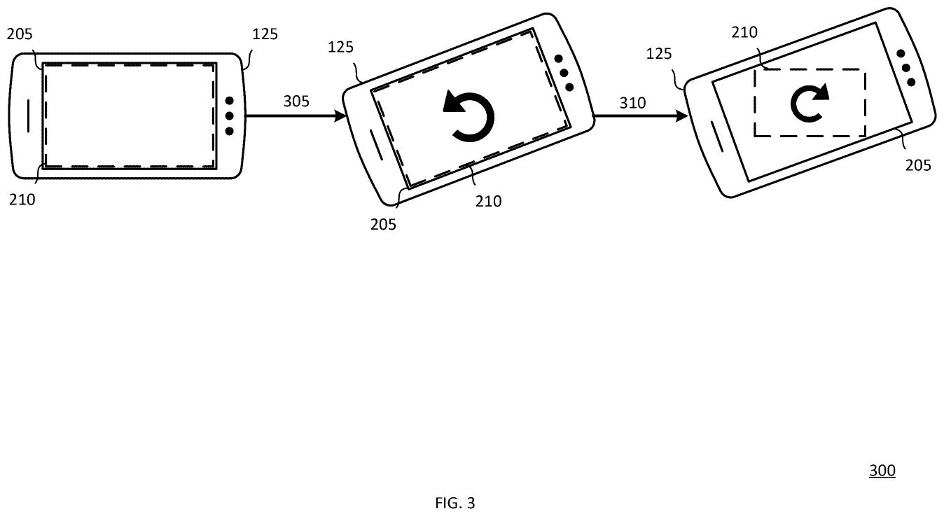

FIG. 3 shows a process 300 according to the present disclosure. The process 300 may be implemented by a computing device 200. The computing device 200 may output a content 210 via the display of the computing device 200. The outputted content 210 may be outputted according to first orientation information, such as a first size and a first rotation. For example, the first orientation information may correspond to a landscape mode of the display 205, wherein the content is configured to maximize the size of the content in the landscape mode.

At 305, the computing device 200 may experience a rotation of the display 205. For example, the computing device 200 may be rotated counter-clockwise, such that the rotation position of the display 205 changes with respect to the original rotation position (e.g., a 40 degree rotation along a plane defined by the display 205). The computing device 200 may determine that the rotation is caused by a sudden jump, vibration, jolt, etc.

At 310, the computing device 200 may alter the orientation of the outputted content 210 based on the experienced rotation. The computing device 200 may determine a new orientation of the outputted content 210 according to the rotation experienced by the display 205 at step 305. In some cases, the computing device 200 may also determine a new size for the outputted content 210. For example, the new size may be configured to fit the entire content within the display 210 according to the new orientation of the display 205. For example, the display may include a portrait mode and a landscape mode, where the portrait mode is a 90 degree rotation from the landscape mode (along the plane defined by the display screen). The new orientation for the display 205 may be between the landscape and portrait modes of the display 205. Thus, the new size may be configured to fit within the dimensions of the screen when the new orientation is between this landscape and portrait modes.

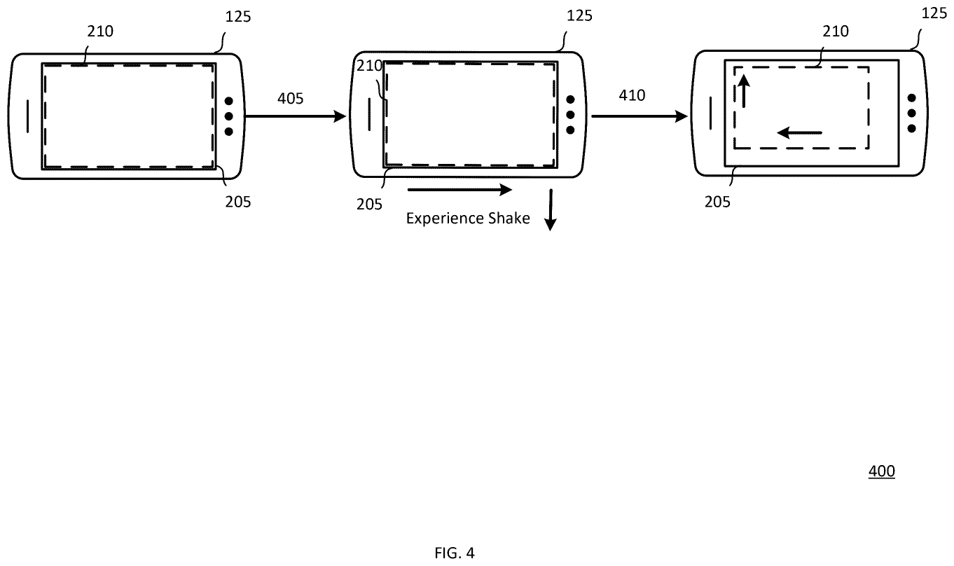

FIG. 4 shows another example of a process 400 according to the present disclosure. The process 400 may be implemented by a computing device 200. The computing device 200 may output a content 210 via the display of the computing device 200. The outputted content 210 may be outputted according to first orientation information, such as a first size and a first rotation. For example, the first orientation information may correspond to a landscape mode of the display 205, wherein the content is configured to maximize the size of the content in the landscape mode.

At 405, the computing device 200 may experience a directional shift of the display 205. For example, the computing device 200 may experience a lateral shift, such that the lateral position of the display 205 changes with respect to the original lateral position (e.g., a 2-inch shift along a direction defined by a length dimension of the display 205, a 1-inch shift along a direction defined by a width dimension of the display 205, etc.). The computing device 200 may determine that the shift or displacement is caused by a sudden shake, jump, vibration, jolt, etc.

At 410, the computing device 200 may alter the positioning of the outputted content 210 based on the experienced shake. For example, the computing device 200 may determine a new center point for the outputted content 210 according to the displacement of the display 205. The new center point may be shifted along the display 205 based on the displacement of the display 205. The center point may be defined as a point on the display where the center of the content outputted 210 exists, for example where the amount of the content outputted in a given direction (e.g., in the width direction of the display 205) is the same as the amount of the content outputted in the opposite direction (e.g., in the negative width direction of the display 205). In some cases, the computing device 200 may also determine a new size for the outputted content 210. For example, the new size may be configured to fit the entire content within the display 210 according to the new center point of the display 205.

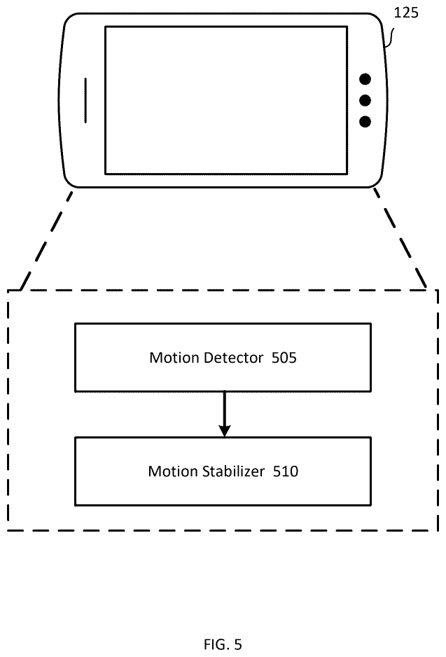

FIG. 5 shows a computing device 125 according to the present disclosure. The computing device 125 can include one or more motion detectors 505. The motion detectors 505 can determine when the computing device 125 experiences particular movements. For example, the computing device 125 may include a displacement detector that is configured to detect a displacement of the computing device 125 in particular directions. For example, the displacement detector may include an accelerometer or other vibration sensors. The one or more motion detectors may also include a rotation motion sensor configured to detect rotation of the computing device 125 (e.g., rotation of the display 205). An example of a rotation motion sensor may be a gyroscope

In some cases, the computing device 125 may also include a motion stabilizer 510. The motion stabilizer 510 may determine updated output parameters for the outputted content based on the detected motion. For example, the motion stabilizer 510 may receive information from the motion detector(s) 505 corresponding to motion experienced by the computing device 125. The motion stabilizer 510 may determine whether the experienced motion meets predefined thresholds corresponding to whether motion stabilization is initiated for the outputted content. For example, the predefined thresholds may indicate whether the computing device 125 is experiencing a jolt, a shake, a vibration, etc. For example, the predefined thresholds may correspond to a certain amount of motion within a given time period (e.g., a predefined angle of rotation threshold or range, a predefined angular velocity threshold or range, a predefined velocity threshold or range, etc.). For example, the angle of rotation may be between 0 and 10 degrees, 0 and 20 degrees, etc. In another example, the motion stabilizer 510 may determine the computing device has moved laterally on the scale of 0 and 5 cms, 0 and 10 cms, etc. (e.g., a jolt, shake, or vibration). If these predefined thresholds are met, the motion stabilizer 510 may determine new output parameters for the outputted content according to the detected motion, such as a new center point for the content, a new rotation position for the content, a new size for the content, a combination thereof, etc. Further, in some cases, some or all of the functions performed by the motion stabilizer 510 may be performed by the computing device 125 (e.g., by the mobile phone or tablet). In some cases some or all of the functions performed by the motion stabilizer 510 may be performed by another entity, such as another computing device or system (e.g., via a cloud system).

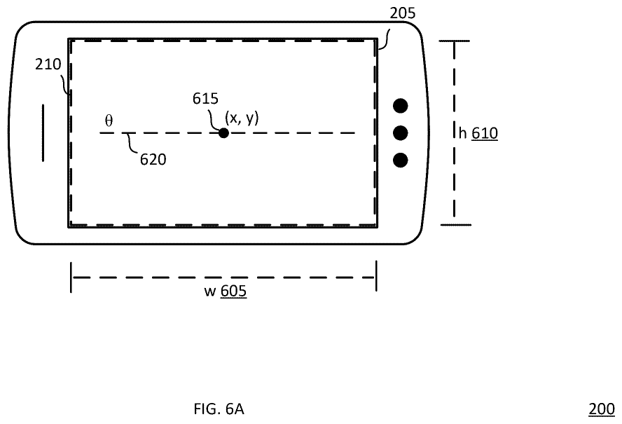

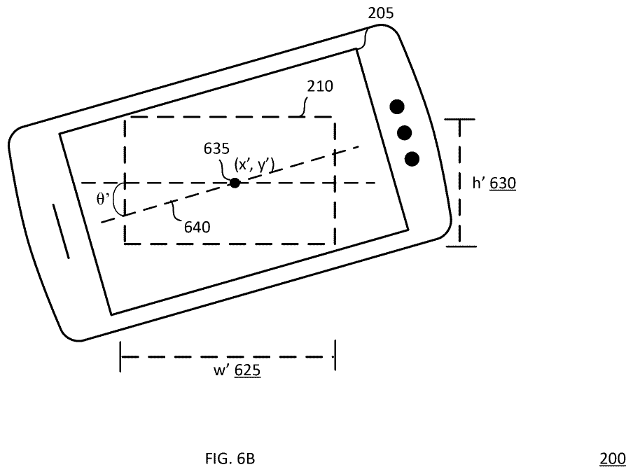

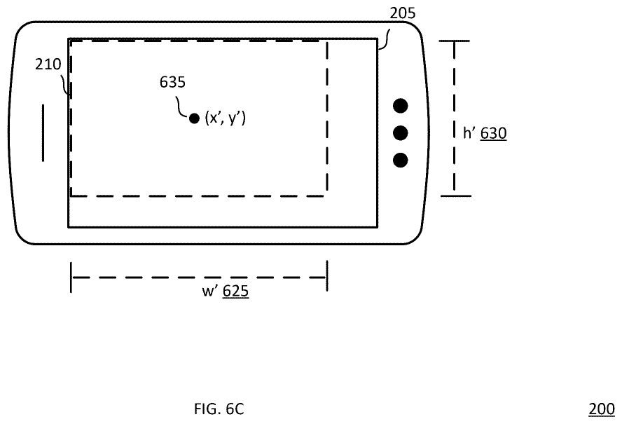

FIG. 6A shows an example of a computing device 200 according to the present disclosure. The computing device 200 may include initial output parameters for the outputted content 210 (e.g., via the display 205). For example, the initial output parameters may include an initial width (w) 605, an initial height (h) 610, an initial center point 615, and an initial tilt angle θ 620.

FIG. 6B shows the computing device 200 having experienced a rotational repositioning according to the present disclosure. The computing device 200 may determine new output parameters for the outputted content 210 according to the determined movement experienced by the computing device 200. The new output parameters can include, for example, a new width (w′) 625, a new height (h′) 630, a new center point (x′, y′) 635, a new rotation θ′ 640, a combination thereof, etc.

As a particular example, a dynamic tilt correction process is described below. The initial orientation of the computing device may be in a landscape orientation in this example. The determinations of the example process may include minimum and maximum tilt angle thresholds. For example, a minimum tilt angle (θₘᵢₙ) may prevent excessive shrinking. The minimum tilt angle may be set to 5 degrees, which may ensure small tilts do not cause the outputted content to excessively shrink. A maximum tilt angle (θₘₐₓ) may limit a maximum angle for stability. The maximum tilt angle may set to 30 degrees, which may avoid extreme adjustments that may confuse users.

Minimum and maximum angular velocities may also be used in the example process. A Minimum Angular Velocity (Gₘᵢₙ) may avoid reacting to minor, insignificant movements. This may be set to 0.5 rad/s to filter out negligible changes. A Maximum Angular Velocity (Gₘₐₓ) may prevent overreacting to rapid movements. This may be set to 2 rad/s to ensure the stabilization algorithm responds to significant tilts

The process may also use accelerometer readings, including: Aₓ: Acceleration along the x-axis; A_{y}: Acceleration along the y-axis; and A_{z}: Acceleration along the z-axis.

The process may also use gyroscope readings, including: Gₓ: Angular velocity around the x-axis; G_{y}: Angular velocity around the y-axis; and G_{z}: Angular velocity around the z-axis.

The process may also use certain dimensions, including: W: Original width of the content; H: Original height of the content; W′=W·S: New width of the content; and H′=H·S: New height of the content, where S is the shrink factor (e.g., the factor by which the dimensions are reduced).

The Tilt angle along an axis can be calculated as:

$${θ}_{a ccel} = arctan ( \frac{{A}_{x}}{{A}_{z}} )$$

(tilt from accelerometer), or where G is the angular velocity, and Δt is the time difference: θ_{gyro}=Gx·Δt (tilt from gyroscope).

The rotation (Tilt) calculation may include combining the accelerometer and gyroscope data to get a smooth estimate of the tilt: θ_{combined}=α·θ_{gyro}+(1−α)·θ_{accel}, where α may be a filter coefficient (e.g., 0.98).

For dimension shrinking, the dimensions of the video content may shrink proportionally to the tilt to maintain the content's visual stability. The tilt angle θ may affects the apparent size of the content. The shrink factor(S) may be modeled as: S=1−k×|sin (θ_{combined})|, where k is a proportionality constant (e.g., 0.1) that controls how much the content shrinks with tilt. The new dimensions (W′, H′) may then be: W′=W×S and H′=H×S. Here, W and H are the original width and height of the content.

For tilt angle:

$${θ}_{a ccel} = arctan ( \frac{{A}_{x}}{{A}_{z}} )$$

(tilt from accelerometer), and θ_{gyro}=Gₓ·Δt (tilt from gyroscope). The combined tilt angle may be: θ_{combined}=α·θ_{gyro}+ (1−α)·θ_{accel}, where α is a filter coefficient (e.g., 0.98).

The shrink factor may be determined as: S=1−k×| sin (θ_{combined})|, where k is a proportionality constant (e.g., 0.1). The new dimensions of the content may be determined as W′=W·S: and H′=H·S.

FIG. 6C shows the computing device 200 having experienced a lateral repositioning according to the present disclosure. The computing device 200 may determine new output parameters for the outputted content 210 according to the determined movement experienced by the computing device 200. The new output parameters can include, for example, a new width (w′) 625, a new height (h′) 630, a new center point 635, a new rotation θ′ 640, a combination thereof, etc.

As a particular example, a dynamic shake stabilization process is described below. The initial orientation of the computing device may be in landscape mode (e.g., top facing left from the user's point of view). The movement may be rapid movement along the x and y directions, which may be the screen's x and y axes.

The process may also include screen reduction limit thresholds. For example, a maximum reduction in height (e.g., 80% of the total screen height), and a maximum reduction in width (e.g., 80% of the total screen width).

The example process may take into account a number of variables. For example: h=Height of the mobile screen; w=Width of the mobile screen; h′=Height of the content; w′=Width of the content; x′=Distance the content moves in the x-direction; y′=Distance the content moves in the y-direction.

The process may also include the receiving of data from the accelerometer sensors. For example, aₓ=Acceleration along the x-direction (unit: m/s²); a_{y}=Acceleration along the y-direction (unit: m/s²); and f=Sampling rate (unit: Hz).

The process may determine motion experienced by the computing device. For example, u=Initial velocity (assumed to be 0 in both x and y directions); a=Acceleration; and t=Time interval. The general equation of motion may be:

$$S = u t + \frac{1}{2} a {t}^{2} .$$

Since the initial velocity u=0 in both x and y directions, equation simplifies to:

$${S}_{x} = \frac{1}{2} {a}_{x} {t}^{2} , and {S}_{y} = \frac{1}{2} {a}_{y} {t}^{2} .$$

The process may also Incorporate a Sampling Rate for the motion sensors. For example, the time interval t may related to the sampling rate f as:

$$t = \frac{1}{f} .$$

Substituting this into the equations for Sₓ and S_{y} provides:

$${S}_{x} = \frac{1}{2} {{a}_{x} ( \frac{1}{f} )}^{2} and {S}_{x} = \frac{{a}_{x}}{2 {f}^{2}} .$$

Similarly, for the y-direction:

$${S}_{y} = \frac{1}{2} {{a}_{y} ( \frac{1}{f} )}^{2} , and {S}_{y} = \frac{{a}_{y}}{2 {f}^{2}} .$$

The process may determine content size adjustments for the outputted content. For example, for the content height and width adjustments: h′=h−Sₓ and w′=w−S_{y}

The process may also take into account negative acceleration data. For example, if aₓ or a_{y} is negative (indicating the computing device is moving downward), the content may be repositioned upward, and vice versa.

The process may also limit content reduction caused by the movement. For example, there is a natural limit to the reduction in content height and width, which may be based on the sizing threshold mentioned above. For example, if h′<0.8h, then h′=0.8h.

The process may include determining content movement in x and y directions. For example, The distance for the content to move in the x and y directions may be: x′=h−h′=Sₓ and y′=w−w′=S_{y}. The process may also include the determining of new sizes for the outputted content. For example, for the height of the Content (h′):

$${h}^{′} = h - \frac{{a}_{x}}{2 {f}^{2}} .$$

For the width of the Content (w′):

$${w}^{′} = w - \frac{{a}_{y}}{2 {f}^{2}} .$$

The process may also determine a new center point for the content. For example, a distance for content to move in x-direction (x′) may be:

$${x}^{′} = {S}_{x} = \frac{{a}_{x}}{2 {f}^{2}} .$$

Likewise, a distance for content to move in y-direction (y′) may be:

$${y}^{′} = {S}_{y} = \frac{{a}_{y}}{2 {f}^{2}} .$$

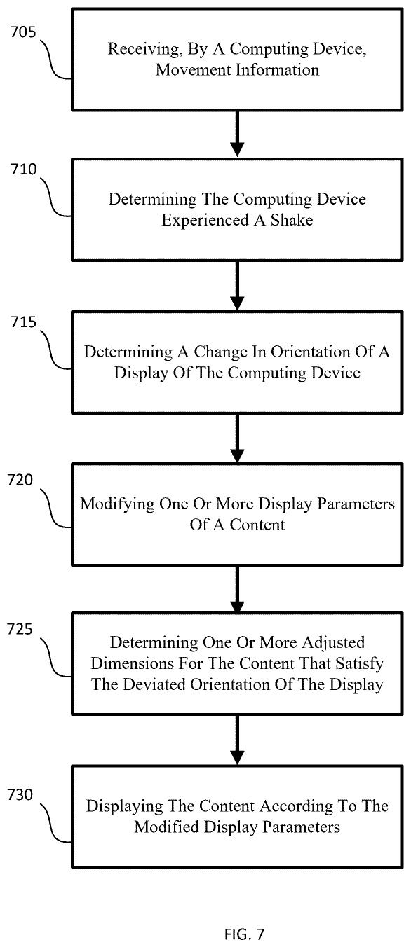

FIG. 7 shows an example method. The method may comprise a computer-implemented method for providing a service (e.g., content stabilization). A system or computing device, such as the computing device 125 of FIG. 1 or the components shown in FIGS. 2-6C or 8, may be configured to perform the method of FIG. 7. The method may be performed in connection with the system 100. Any step or combination of steps of the method may be performed by a computing device, network device, network node, and/or client device, such as the devices shown in FIG. 1. Any of the features of FIG. 7 may be combined with any of the features and/or steps of the methods of FIGS. 3-6C.

At Step 705, information corresponding to a movement of a computing device may be received. The computing device may be a device capable of outputting content via a display. For example, the computing device may be a mobile phone, a tablet, a gaming console, a smartwatch, etc. The movement of the computing device may be detected, measured, sensed, etc., by one or more motion detectors of the computing device. For example, the motion detector(s) may include an accelerometer, a gyroscope, or both. In some cases, the movement of the computing device may be a lateral movement, a rotational movement, or both. In some cases, the movement may be a shake or a jolt.

At Step 710, a determination the computing device experienced a shale may be made. The determination may be made based on the information corresponding to the movement of the computing device. The movement of the computing device may meet a predefined threshold. For example, the movement may be within a predefined angle of rotation range. For example, the movement may be determined to be with 1 degree angle of rotation (e.g., of the display) and 5 degrees, between 1 and 3 degrees, between 1 and 10 degrees, between 0.1 and 1 degrees, etc. In some cases, the movement of the computing device may be within a predefined lateral movement range (e.g., along the dimensions of the display). For example, the movement may be determined to be between 0.1 inches and 1 inch, between 0.1 inches and 0.5 inches, between 0.5 inches and 1 inch, between 0.1 inch and 2 inches, between 1 inch and 2 inches, between 1 inch and 5 inches, etc. In some cases, the movement may be determined to occur within a predefined time period. For example, the movement may occur within 0.1 seconds, within 0.5 seconds, within 1 second, within 2 seconds, etc. If the movement meets the predefined threshold, the computing device may determine the computing device experienced a shake or a jolt. Thus, the computing device may be able to differentiate between the computing device experiencing a shake or jolt, and the computing being repositioned to switch from a portrait mode to a landscape mode 9 or vice versa) by the user.

At Step 715, a deviation in orientation of a display of the computing device may be determined. The deviation in orientation may be with respect to a first orientation of the display. The deviation in orientation may be based on the information corresponding to the movement. The first orientation of the display may correspond to an initial orientation of the display prior to the movement of the computing device occurring.

At Step 720, one or more output parameters of a content may be modified. The one or more output parameters may include a width, a height, an angle of rotation, a center point, or a combination thereof. The modifying may be based on the change in orientation of the display. The modifying may be based on the first orientation. For example, the first orientation may correspond to a set of initial output parameters, such as an initial width, an initial height, an initial angle of rotation, an initial center point, or a combination thereof. In some cases, the initial set of output parameters may correspond to a landscape or portrait mode of the computing device. For example, the set of initial parameters may cause the content to be outputted with a 0 degree rotation with respect to the landscape mode of the display, and the outputted dimensions of the content may be such that the dimensions correspond to the dimensions of the display. Further, the modifying may be performed on the set of initial parameters. In some cases, the output parameters may be an angle of rotation of the content with respect to the first orientation, a deviation in a center point of the content with respect to the first orientation, or both.

At Step 725, one or more adjusted dimensions for the content may be determined. The one or more adjusted dimensions may be based on the modified one or more output parameters. The one or more adjusted dimensions may satisfy the deviated orientation of the display. For example, the adjusted dimensions may include a decreased height of the content, a decreased width of the content, or both. The dimensions of the content may be adjusted to fit within the deviated orientation of the display, which may be between a portrait mode and a landscape mode of the display.

At Step 730, the computing device may output the content according to the modified output parameters. The content may be outputted with, for example, a modified width, a modified height, a modified angle of rotation, a modified center point, or a combination thereof. The content may be outputted such that a size of the content is configured to fit within the display according to the modified output parameters. For example, the content dimensions may be reduced with respect to the output parameters corresponding to the first orientation.

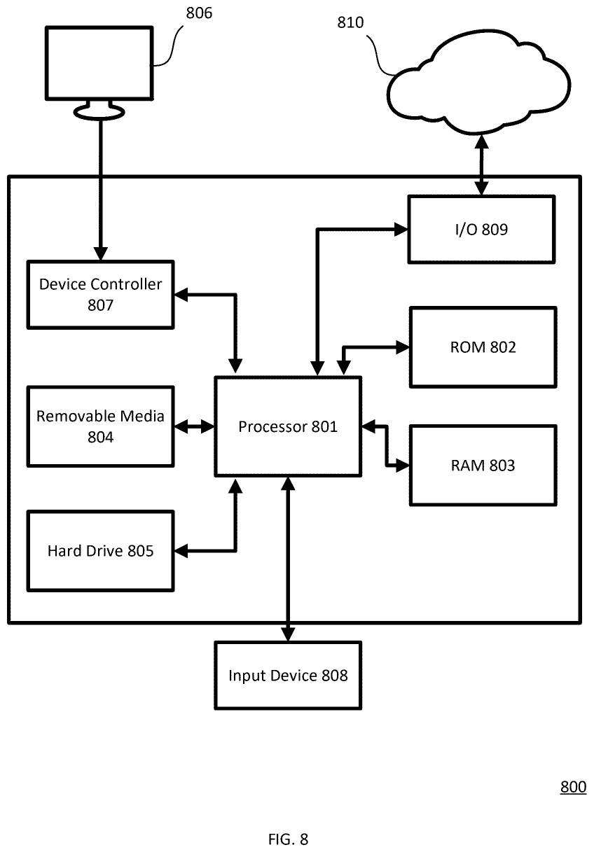

FIG. 8 shows hardware elements of a computing device that may be used to implement any of the computing devices discussed herein (e.g., the servers, devices, a controller server, end user device, receiving computing device, etc.). The computing device 800 may include one or more processors 801, which may execute instructions of a computer program to perform any of the functions described herein. The instructions may be stored in a read-only memory (ROM) 802, random access memory (RAM) 803, removable media 804 (e.g., a Universal Serial Bus (USB) drive, a compact disk (CD), a digital versatile disk (DVD)), and/or in any other type of computer-readable medium or memory. Instructions may also be stored in an attached (or internal) hard drive 805 or other types of storage media. The computing device 800 may include one or more output devices, such as a display 806 (e.g., an external television or other display device), and may include one or more output device controllers 807, such as a video processor. There may also be one or more user input devices 808, such as a remote control, keyboard, mouse, touch screen, microphone, graphical user interface (GUI), etc. The computing device 800 may also include one or more network interfaces, such as a network input/output (I/O) circuit 809 (e.g., a network card) to communicate with an external network 810, which in some cases may be an example of external network 109 of FIG. 1. The network input/output circuit 809 may be a wired interface, wireless interface, or a combination of the two. The network input/output circuit 809 may include a modem (e.g., a cable modem), and the external network 810 may include the communication links 101 discussed above, the external network 109, an in-home network, a network provider's wireless, coaxial, fiber, or hybrid fiber/coaxial distribution system (e.g., a DOCSIS network), or any other desired network.

Although FIG. 8 shows an example hardware configuration, one or more of the elements of the computing device 800 may be implemented as software or a combination of hardware and software. Modifications may be made to add, remove, combine, divide, etc. components of the computing device 800. Additionally, the elements shown in FIG. 8 may be implemented using basic computing devices and components that have been configured to perform operations such as are described herein. For example, a memory of the computing device 800 may store computer-executable instructions that, when executed by the processor 801 and/or one or more other processors of the computing device 800, cause the computing device 800 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein.

Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A method comprising:
receiving, by a computing device, information corresponding to a movement of the computing device;
determining, based on the movement satisfying a predefined threshold, the computing device experienced a shaking movement;
determining, based on the information corresponding to the movement and determining the computing device experienced a shaking movement, a change in orientation of a display of the computing device with respect to a first orientation of the display;
modifying, based on the determined change in orientation of the display, one or more output parameters of a content; and
outputting, by the computing device, the content according to the one or more modified output parameters.

2. The method of claim 1, wherein the movement of the computing device comprises a lateral movement of the computing device, a rotational movement of the computing device, or both.

3. The method of claim 1, wherein the one or more output parameters comprise an angle of rotation of the content with respect to the first orientation, a change in a center point of the content with respect to the first orientation, or both.

4. The method of claim 1, further comprising:
measuring, by one or more sensors of the computing device, the movement of the computing device.

5. The method of claim 4, wherein the one or more sensors comprise an accelerometer, a gyroscope, or both.

6. The method of claim 1, wherein the computing device comprises a mobile phone or a tablet.

7. The method of claim 1, wherein the one or more output parameters comprise a height of the content, a width of the content, or both.

8. The method of claim 1, further comprising determining one or more output parameters corresponding to the first orientation, wherein the modifying is further based on the one or more output parameters corresponding to the first orientation.

9. A computing device, comprising:
one or more processors;
memory; and
a set of instructions stored in the memory that, when executed by the one or more processors, cause:
receiving, by the computing device, information corresponding to a movement of the computing device;
determining, based on the movement satisfying a predefined threshold, the computing device experienced a shaking movement;
determining, based on the information corresponding to the movement and determining the computing device experienced a shaking movement, a change in orientation of a display of the computing device with respect to a first orientation of the display;
modifying, based on the determined change in orientation of the display, one or more output parameters of a content; and
outputting, by the computing device, the content according to the one or more modified output parameters.

10. The computing device of claim 9, wherein the movement of the computing device comprises a lateral movement of the computing device, a rotational movement of the computing device, or both.

11. The computing device of claim 9, wherein the set of instructions, when executed by the one or more processors, further cause:
measuring, by one or more sensors of the computing device, the movement of the computing device.

12. The computing device of claim 11, wherein the one or more sensors comprise an accelerometer, a gyroscope, or both.

13. The computing device of claim 9, wherein the one or more output parameters comprise a height of the content, a width of the content, a center point of the content, a rotational angle of the content, or a combination thereof.

14. The computing device of claim 9, wherein the set of instructions, when executed by the one or more processors, further cause:
determining one or more output parameters corresponding to the first orientation, wherein the modifying is further based on the one or more output parameters corresponding to the first orientation.

15. The computing device of claim 9, wherein the computing device comprises a mobile phone or a tablet.

16. A non-transitory, computer-readable medium comprising a set of computer-executable instructions that, when executed by one or more processors, cause:
receiving, by a computing device, information corresponding to a movement of the computing device;
determining, based on the movement satisfying a predefined threshold, the computing device experienced a shaking movement;
determining, based on the information corresponding to the movement and the determining the computing device experienced a shaking movement, a change in orientation of a display of the computing device with respect to a first orientation of the display;
modifying, based on the determined change in orientation of the display, one or more output parameters of a content; and
outputting, by the computing device, the content according to the one or more modified output parameters.

17. The non-transitory, computer-readable medium of claim 16, wherein the movement of the computing device comprises a lateral movement of the computing device, a rotational movement of the computing device, or both.

18. The non-transitory, computer-readable medium of claim 16, wherein the set of computer-executable instructions, when executed by the one or more processors, further cause:
measuring, by one or more sensors of the computing device, the movement of the computing device.

19. The non-transitory, computer-readable medium of claim 16, wherein the one or more output parameters comprise a height of the content, a width of the content, a center point of the content, a rotational angle of the content, or a combination thereof.

20. The non-transitory, computer-readable medium of claim 16, wherein the computing device comprises a mobile phone or a tablet.
